(19) United States
(12) Patent Application Publication
(10) Pub. No.: US 2013/0265764 A1
(43) Pub. Date: Oct. 10, 2013

(54) LIGHTING DEVICE

(71) Applicants: Robert L. Holman, San Jose, CA (US); Matthew B. Sampsell, San Jose, CA (US)

(72) Inventors: Robert L. Holman, San Jose, CA (US); Matthew B. Sampsell, San Jose, CA (US)

(73) Assignee: QUALCOMM MEMS Technologies, Inc., San Diego, CA (US)

(21) Appl. No.: 13/443,646

(22) Filed: Apr. 10, 2012

(51) Int. Cl. F21V 21/14; B23P 11/00

(52) U.S. Cl. 362/249.02; 362/418; 29/428

(57) ABSTRACT

This disclosure provides systems, methods and apparatus for lighting devices. In one aspect, a lighting device includes a light engine and a connection portion. The connection portion can include a first end coupled to the light engine and a base connector disposed at the second end of the connection portion. In some implementations, the connection portion has a length dimension that is adjustable between at least a first length that positions the base connector at a first position relative to the light engine and a second length that positions the base connector at a second position relative to the light engine.

### TECHNICAL FIELD

This disclosure relates to lighting devices.

### DESCRIPTION OF THE RELATED TECHNOLOGY

Some lighting devices can include a light emitting portion that includes a light engine which emits light, and a base. The base extends from the light emitting portion and includes a connector configured to be coupled with an electrical connection (for example, a socket) which provides power to the lighting device and provides mechanical support for the lighting device. Such lighting devices include standard incandescent bulbs where part of the base and the light engine are integrated and formed from glass, and include a threaded base configured to fit into an Edison socket. Other implementations include a variety of designs of the light engine and the base for different types of light engines (e.g., LED, halogen and compact fluorescent). In use, many lighting devices are placed at least partially in a light fixture. In many cases, a lighting device is placed in the light fixture such that a light emitting surface of the lighting device is at the plane of the opening of the recess of the light fixture, or set into the recess so that the light emitting surface is within the recess of the light fixture. Lighting devices are manufactured to have specific connection portion dimensions in order to be used with certain light fixtures such that they fit into the recess of the light fixture as desired.

### SUMMARY

The systems, methods and devices of the disclosure each have several innovative aspects, no single one of which is solely responsible for the desirable attributes disclosed herein.

One innovative aspect of the subject matter described in this disclosure can be implemented in a lighting apparatus including a light engine and a connection portion. The connection portion includes a first end and a second end. The first end of the connection portion is coupled to the light engine and extends from the light engine in a direction defining a longitudinal axis. The connection portion also includes a base connector disposed at the second end of the connection portion and the base connector is electrically connected to the light engine through the connection portion. The connection portion has a length dimension that is adjustable between at least a first length that positions the base connector at a first position along the longitudinal axis relative to the light engine and a second length that positions the base connector at a second position along the longitudinal axis relative to the light engine.

In one aspect, the connection portion can be lockable, at least temporarily, in at least one of the first and second positions. In one aspect, a minimum cross-sectional dimension of the light engine can be greater than a maximum cross-sectional dimension of the connection portion. In one aspect, the length dimension of the connection portion can be adjusted between 1″ and 9″, for example, between 1″ and 4″ or between 4″ and 9″. In one aspect, the length dimension of the connection portion can be telescopically adjustable. The connection portion can include a spring to bias the connection portion toward the second length. In one aspect, the light engine can include a light emitting surface and a back surface opposite to the light emitting surface. The connection portion can be coupled to the back surface of the light engine.

Another innovative aspect of the subject matter described in this disclosure can be implemented in a lighting device having a longitudinal axis and including a light engine, an electrical connector configured to connect to a light fixture, and means for adjusting a longitudinal length dimension between the light engine and the electrical connector. The length adjusting means is coupled to the light engine and the electrical connector and is configured to adjust between at least a first length that positions the electrical connector at a first position along the longitudinal axis relative to the light engine and a second length that positions the electrical connector at a second position along the longitudinal axis relative to the light engine.

In one aspect, the light adjusting means can be at least temporarily lockable in at least one of the first and second positions. The light engine can include one of an incandescent bulb, a fluorescent tube, and a light engine. In one aspect, the electrical connector can include an Edison screw. The length adjusting means can include a connection portion extending along the longitudinal axis. The connection portion can have a first end and a second end with the first end of the connection portion being coupled to the light engine

Another innovative aspect of the subject matter described in this disclosure can be implemented in a method of installing a lighting device within a light fixture recess having an opening and an electrical connection opposite to the opening. The method includes providing a lighting device having a light engine and a connection portion extending along a longitudinal axis of the lighting device, the light engine having a light emitting surface, the connection portion having a first end coupled to the light engine and a second end opposite the first end and coupled to a base connector. The method also includes coupling the base connector with the electrical connection and adjusting a length dimension of the connection portion between the first end and the second end to move a position of the light engine relative to the base connector between at least a first position and a second position.

In one aspect, the length dimension of the connection portion when the light engine is in the first position can be greater than the length dimension of the connection portion when the light engine is in the second position. In one aspect, the opening can be disposed between the light emitting surface and the electrical connection when the light engine is in the second position, the light emitting surface can be flush with the opening when the light engine is in the second position, or the light emitting surface can be disposed between the opening and the electrical connection when the light engine is in the second position. The method can also include at least temporarily locking the connection portion when the light engine is in the first position and/or locking, at least temporarily, the connection portion when the light engine is in the second position.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a perspective view of an example of lighting device including a light engine and a connection portion.

FIG. 1B shows a perspective view of an implementation of the light engine of FIG. 1A illustrated without the connection portion.

FIG. 1C shows a partial perspective view of the connection portion of FIG. 1A illustrated without the light engine.

FIGS. 2A and 2B show side views of an example lighting device illustrated with an example light fixture.

FIGS. 3A-3C show side views of the example lighting device of FIGS. 2A and 2B illustrated with another example light fixture.

FIGS. 3D and 3E show side views of the example lighting device of FIGS. 2A and 2B illustrated with another example light fixture.

FIGS. 4A and 4B show flow diagrams illustrating example methods of installing a lighting device.

FIG. 5A shows a side view of an example lighting device including a connection portion having a length dimension that is adjustable.

FIG. 5B shows the example lighting device of FIG. 5A with the length dimension of the connection portion adjusted relative to the length dimension illustrated in FIG. 5A.

FIG. 6A shows a side view of an example lighting device including a connection portion having a length dimension that is adjustable.

FIG. 6B shows a cross-sectional view of the example lighting device of FIG. 6A.

FIG. 6C shows the example lighting device of FIG. 6B with the length dimension of the connection portion adjusted relative to the length dimension illustrated in FIGS. 6A and 6B.

FIG. 7A shows an exploded view of an example lighting device including a connection portion having a length dimension that is adjustable.

FIG. 7B shows a side view of the example lighting device of FIG. 7A with the connection portion temporarily locked in a first position.

FIG. 7C shows the example lighting device of FIG. 7B with the length dimension of the connection portion adjusted relative to the length dimension illustrated in FIG. 7B and temporarily locked in a second position.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. It is contemplated that the described implementations may be included in or associated with lighting used for a wide variety of applications such as, but not limited to: commercial, industrial, and residential lighting. Implementations may include but are not limited to lighting in homes, offices, manufacturing facilities, retail locations, hospitals and clinics, convention centers, cultural institutions. libraries, schools, government buildings, warehouses, military installations, research facilities, gymnasiums, sports arenas, or lighting in other types environments or applications. In various implementations the lighting may be overhead lighting and may project downward a spotlight having an area that is larger (for example, several times or many times larger) than an area of a light emitting surface of a lighting device. Thus, the teachings are not intended to be limited to the implementations depicted solely in the Figures, but instead have wide applicability as will be readily apparent to one having ordinary skill in the art.

In some implementations, a lighting device or apparatus can include a light engine component and a connection portion for electrically and/or mechanically coupling the lighting device to a light fixture. As used herein, the term “light fixture” refers to any fixture or structure configured to be electrically and/or mechanically coupled to any portion of a lighting device, for example, a recessed light housing, a downlight fixture, a can fixture, a pot light fixture, a cove light fixture, a torch lamp fixture, a pendant light fixture, a sconce fixture, a track light fixture, and/or a bay light fixture.

In some implementations, the connection portion can include a stem extending from the light engine, and include a base connector for electrically and/or mechanically coupling the lighting device to an electrical connection. The base connector can be, for example, an Edison connector configured to electrically and mechanically couple to an electrical connection of the light fixture. When electrically and/or mechanically coupled to the electrical connection, at least part of the connection portion of the lighting device may be disposed within a recess of the light fixture. At least some, or all, of the light engine can also be disposed in the recess of the light fixture. For example, in some “can” light fixtures, all of the stem is within the recess of the light fixture. An electrical connection (such as an Edison socket) of the light fixture that receives the light device base connector can also be disposed within the recess of the light, or in some implementations it is adjacent to or behind the recess and accessible through the recess. Accordingly, in use the base connector of the lighting device can also be disposed within the recess of the light fixture depending on the location of the corresponding light fixture electrical connection.

The depths and other dimensions of light fixture recesses can vary from light fixture to fixture. Accordingly, the variations in recess dimensions can result in the light engine and the stem of a lighting device being exposed beyond the recess if the connection portion of the lighting device is not appropriately dimensioned for the corresponding light fixture. That is to say, the connection portion of a lighting device may have a longitudinal length that is greater than the longitudinal depth of a corresponding light fixture recess such that the light engine is not contained within the recess, extends outside of the reset, or is otherwise offset or spaced apart from the light fixture when installed.

Further, these variations in recess dimensions can preclude the use of certain lighting devices with some light fixtures. For example, a connection portion may have a longitudinal length that is significantly less than the longitudinal depth of a light fixture recess such that inserting the connection portion into the light fixture does not result in the connector reaching the electrical connection, or such that the combined efficiency of the lighting device and the light fixture is compromised due to the light engine being too deeply inset within the recess of the light fixture. As a result, lighting devices including connection portions that are not selected for use with a particular light fixture may not be aesthetically pleasing when installed and/or may not fit properly within the recess of the particular light fixture. Implementations of this disclosure relate to lighting devices including connection portions that have length dimensions that are adjustable or otherwise variable.

Particular implementations of the subject matter described in this disclosure can be implemented to realize one or more of the following potential advantages. A lighting device having an adjustable or otherwise variable connection portion can be used or installed with light fixtures having differently dimensioned recesses. For example, a single lighting device can be properly installed in a light fixture having a nine inch deep recess or a light fixture having a four inch deep recess. Thus, a new lighting device may not be required when switching between light fixtures having different recess depths or when moving a lighting device from one light fixture to another. Further, a light engine of such lighting devices can be installed in different positions relative to a particular light fixture having given recess depth dimensions. For example, a lighting device having an adjustable length connection portion can be installed within a light fixture such that the light engine of the lighting device is flush with an opening of the light fixture recess, within the light fixture recess, or exposed outside of the light fixture recess. Thus, a lighting device can be provided with a very thin light engine having a back surface that may lie flush with a surface surrounding a light fixture opening. Such a lighting device may be pleasing to the eye and can provide a cost efficient way of fitting a lighting device with a light fixture recess without requiring other decorative aspects or structures to shroud or adorn the light engine of the lighting device. Further, by controlling whether a light engine is recessed relative to a light fixture opening, the amount of light lost in the light fixture due to recessing can be controlled. For example, the length of a connection portion can be adjusted to avoid inefficiencies from the light engine being too recessed and/or inefficiencies due to shadowing from the output aperture. Similarly, glare effects can be controlled by reducing higher angle light by shadowing or recessing a light engine relative to a light fixture opening.

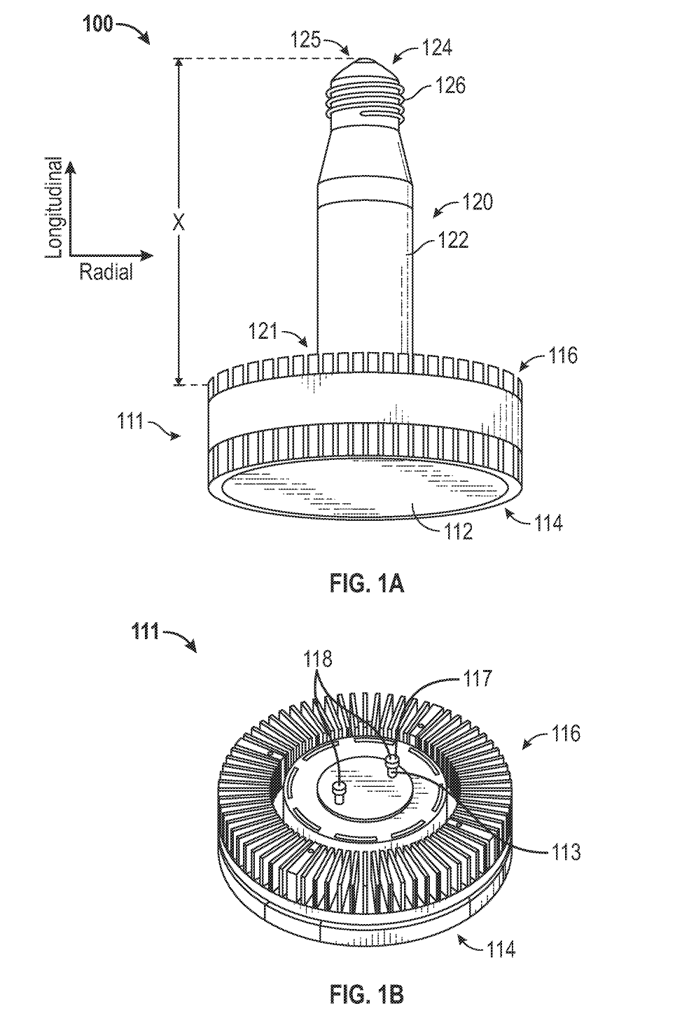

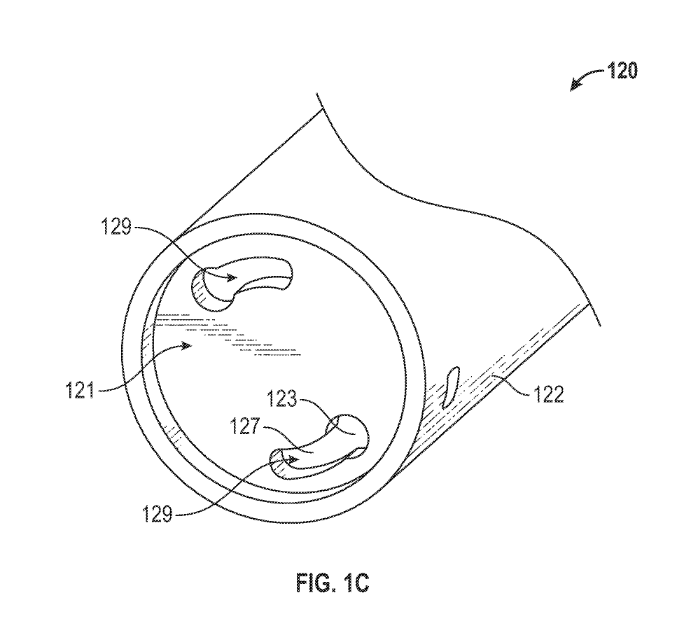

FIG. 1A shows a perspective view of an example of lighting device 100 including a light engine 111 and a connection portion 120. To assist in the description of the implementations described herein, the following coordinate terms are used, consistent with the coordinate axes illustrated in FIG. 1A. A “longitudinal axis” is generally parallel to the connection portion 120 of the lighting device 100. A “radial axis” is any axis that is normal to the longitudinal axis. In addition, as used herein, “the longitudinal direction” refers to a direction substantially parallel to the longitudinal axis and “the radial direction” refers to a direction substantially parallel to a radial axis.

As illustrated in FIG. 1A, the light engine 111 can have a front side 114 and a back side 116. The front side 114 can include a light emitting surface or aperture 112 configured to provide light to a space or volume. In some implementations, a minimum cross-sectional dimension of the light engine 111 taken through the longitudinal axis can be greater than a maximum cross-sectional dimension of the connection portion 120 taken through the longitudinal axis. In other words, the light engine 111 can have a minimum radial dimension that is greater than a maximum radial dimension of the connection portion 120. As a result, the connection portion 120 may be sized and shaped to fit within a recess of a light fixture and the light engine 111 can be sized and shaped to provide a desired output of light.

As used herein, a light engine refers to any structure that includes at least one light emitter or light emitting element and optical structures associated with the at least one light emitter or light emitting element. For example, a light engine can include a light bulb including a filament light as a light emitter and a diffusive glass bulb surrounding the filament as an optical structure associated with the light emitter. Another example of a light engine can include a light-emitting diode (“LED”) optically coupled to a light guide where the light guide includes means for ejecting light out of the light guide. In thin illumination light engines, the means for ejecting light can include a tapered light guide, as discussed below. In some implementations, the means for ejecting light can include light ejecting facets and/or dot structures. Although illustrated in a particular implementation, the light engine 111 can also include other light engines capable of providing visible light, including, for example, an incandescent bulb, a fluorescent tube, another implementation of a light engine, or any other suitable source of light.

In some implementations, the light engine 111 of FIG. 1A can include a light emitter, for example, one or more LED elements, a thin light guide configured to receive light from the light emitter, and an optical coupler, for example, a reflector, configured to couple light from the light emitter into the light guide. In some implementations, the light guide can include a reflective surface configured to reflect light propagating in the light guide toward the light emitting surface 112 and the reflective surface and light emitting surface 112 can meet at a peripheral edge of the light guide. In some implementations, the reflective surface and the light emitting surface 112 can define an angle between 3 degrees and 5 degrees. In this way, the light engine 111 can be configured to emit light through the light emitting surface 112 in a direction substantially perpendicular to a plane of the light emitting surface 112. That is to say, the light engine 111 can be configured to provide a highly collimated beam of light, for example a beam with a full width at half maximum of plus or minus fifteen (+/−15) degrees from the direction of peak brightness.

In some implementations, the light engine can include one or more optical conditioners disposed adjacent to the light emitting surface 112 and configured to provide various shapes and types of far-field lighting, for example, a spotlight, a widely spread beam, or a diffuse light, and shaped as circular, square, or rectangular. In some implementations, the optical conditioner is a thin film including a lenticular lens which is configured to provide various beam shapes. In some implementations, the light engine 111 can include one or more heat transfer structures configured to dissipate heat or thermal energy from the light engine 111. For example, the light engine 111 can include one or more heat transfer fins configured to dissipate heat from a light guide of the light engine 111.

Still referring to FIG. 1A, the connection portion 120 extends from the back side 116 of the light engine 111 in the longitudinal direction and includes a first end 121 which is coupled to the light engine 111 and a second end 125 disposed opposite to the first end 121. In some implementations, the connection portion 120 can include a stem 122 extending at least partially between the first end 121 and the second end 125. As shown, the second end 125 of the connection portion 120 can include a base connector 124 (sometimes herein simply referred to as a “connector”), for example, an Edison screw connector having threads 126. In this way, the base connector 124 can electrically and/or mechanically couple the lighting device 100 with an electrical connection, for example, an electrical connection disposed in a recess of a light fixture. Although illustrated in FIG. 1A as an Edison screw connector (such as E26), the base connector 124 of the connection portion 120 can include other types of connector structures, including but not limited to, a two or three terminal connector where one or more of the terminals are positioned on the end of the base connector and/or the side of the base connector. For example, the base connector 124 can include a BA5s, BA7s, BAX9s, BA9s, BA15d, BAX15s, BA15s, BA20s, BA20d, B21d, B21-4, BA22d, BC-3, B22d-3, BX22d, B15d, BA15d, BA15s, BA20d, B21s-4, B22d, BY22d, B24S-3, GU10, GZ10, or GU24 type connector. The base connector 124 can be electrically connected to the light engine 111, for example, through the stem 122, to provide energy to the light engine 111.

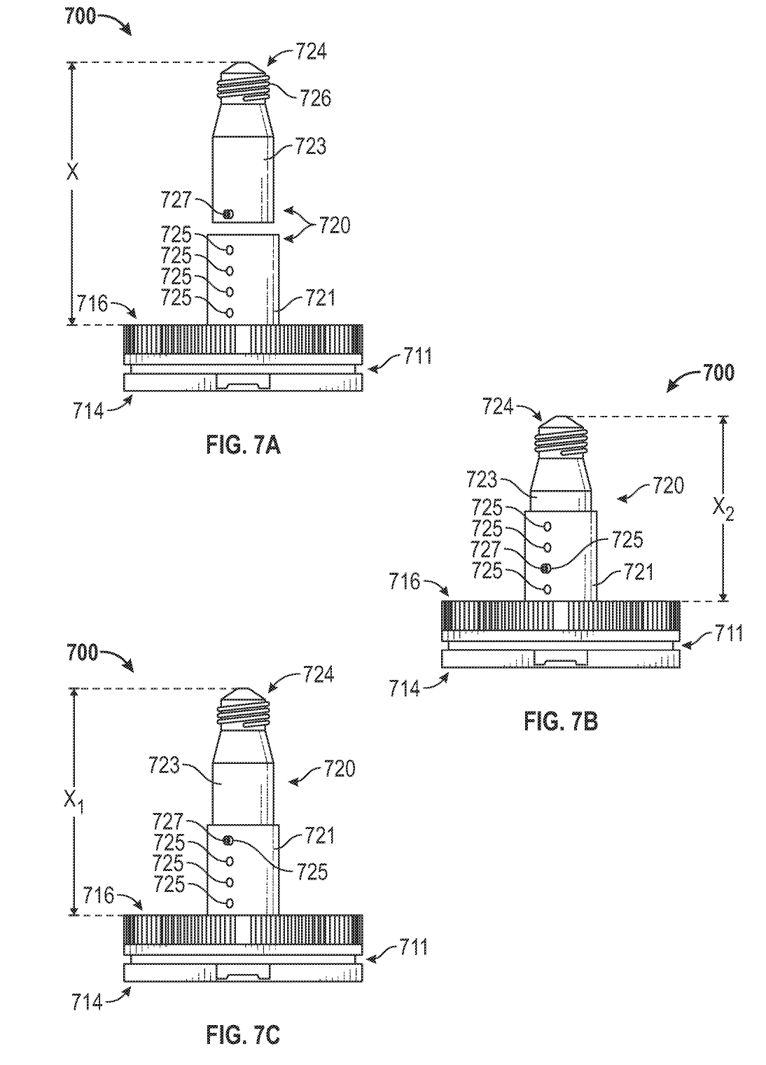

In some implementations, the connection portion 120 is configured to have a length dimension “X” that is adjustable or otherwise variable. For example, the connection portion 120 can be configured such that the length dimension X of the connection portion 120 can be adjusted between 1″ and 6″, or more. In this way, a position of the base connector 124 relative to the light engine 111 can be adjusted between two or more positions. Similarly, a position of the light engine 111 relative to the base connector 124 can be adjusted between two or more positions. For example, the length dimension X can be adjusted such that the base connector 124 is offset from the back side 116 of the light engine 111 in the longitudinal direction by a specific distance. In some implementations, the connection portion 120 can include six telescoping sections having a longitudinal length of one inch each. In such implementations, the connection portion 120 can be adjusted between 1″ and 6″ by moving the telescopic sections of the connection portion 120 relative to one another. In some implementations, the maximum possible adjustable distance between the light engine 111 and the base connector 124 can be about twice the minimum possible adjustable distance (for example, in an implementation with a screw, or the implementation of FIGS. 7A-7C). For example, in some implementations, the connection portion 120 can adjust between 3″ and 4″. In various implementations, the range in inches of possible connector portion 120 lengths can be characterized by ranges of numerical values with the first numerical digit corresponding to a minimum adjustable length and the second numerical digit corresponding to a maximum adjustable length. Examples of these pairs of numerical values and ranges in inches of possible connector portion 120 lengths include (<1-5), (1-6), (<1-4), (1-5), (2-6), (<1-3), (1-4), (2-5), (3-6), (<1-2), (1-3), (2-4), (3-5), (4-6), (<1-1), (1-2), (2-3), (3-4), (4-5), and (5-6). Of course, a person having ordinary skill in the art will readily appreciate that a numerical value of <1 corresponding to a minimum adjustable length means that the back side 116 of the light engine 111 can be less than one inch from the bottom of the base connector 124. For example, the back side 116 of the light engine 11 can abut the bottom of the base connector 124 and be zero inches from the base connector 124.

In some implementations, the stem 122 may provide for the adjustment of the length dimension X of the connection portion 122. While the connection portion 120 can be configured so that the length dimension X of the connection portion 122 can be adjustable to move the base connector 124 between two or more positions relative to the light engine 111, or to move the light engine 111 between two or more positions relative to the base connector 124, in some implementations, the connection portion 120 may be biased toward a particular length dimension X. In this way, the base connector 124 may be adjustable between at least a first position and a second position relative to the light engine 111 but the base connector 124 may be biased toward one of the first or second positions. Similarly, the light engine 111 may be adjustable between at least a first position and a second position relative to the base connector 124 but the light engine 111 may be biased toward one of the first or second positions. In other words, when one of the base connector 124 and the light engine 111 is held in place, the position of the other of the base connector 124 and the light engine 111 can be moved and it can be biased towards a certain position. For example, the bias of the connection portion 120 can be to a full extension, a full retraction, or somewhere in-between,

With continued reference to FIG. 1A, in some implementations, the connection portion 120 lighting device 100 can be releasably locked in one or more positions to be temporarily locked in one or more positions. For example, the connection portion 120 can be locked in a first configuration or position and the connection portion 120 can be adjusted to a second configuration or position where the length dimension X of the connection portion 120 is different in each of the first and second configurations. In some implementations, the connection portion 120 can be permanently locked in a position. In this way, the length dimension X of the connection portion 120 can be adjusted or varied to a desired length and the connection portion 120 can be set or locked at this desired length. As discussed in further detail below, a lighting device having an adjustable length connection portion, such as the lighting device 100, can be installed in light fixtures having different recess dimensions and/or can be adjusted relative to a specific light fixture to position the light engine 111 relative to the light fixture.

FIG. 1B shows a perspective view an implementation of the light engine 111 of FIG. 1A illustrated without the connection portion 120. FIG. 1C shows a partial perspective view of the connection portion 120 of FIG. 1A illustrated without the light engine 111. As illustrated, in some implementations, the back side 116 of the light engine 111 can include one or more electrical connection contacts 118. In some implementations, the contacts 118 can include two or more prongs, blades, or pins, extending longitudinally from the back side 116 of the light engine 111. The first end 121 (not shown in FIG. 1B) of the connection portion 120 can include two or more terminals 129 configured to receive the contacts 118 of the light engine 111. In this way, the connection portion 122 can be electrically and/or mechanically coupled to the light engine 111 via the engaging structure of the contacts 118 of the light engine 111 and the terminals 129 disposed at the first end 121 of the connection portion 120. In some implementations, the connection portion 120 can include one or more wires or conductive traces extending between the light engine 111 and the base connector of the connection portion 120.

As shown in FIG. 1B, each contact 118 of the light engine 111 can include a proximal portion 113 extending from the back side 116 of the light engine 111 and a distal portion 117 extending from the proximal portion 113. In some implementations, the distal portion 117 can be enlarged or flared relative to the proximal portion 113 such that the distal portion 117 has a minimum radial dimension that is greater than a maximum radial dimension of the proximal portion 113. As shown in FIG. 1C, each terminal 129 can include as slot having a first portion 123 and a second portion 127. The first portion 123 can be sized and shaped to receive the distal portion 117 of a contact 118. The second portion 127 can be sized and shaped to inhibit the longitudinal movement or withdrawal of a received contact 118 by abutting or otherwise engaging the distal portion 117 of the received contact 118. In this way, the terminals 129 and contacts 118 can engage one another to releasably or temporarily secure the connection portion 120 relative to the light engine 111.

In some implementations, a light engine 111 may be provided with a plurality of connection portions such that a configuration of a lighting device formed by the light engine 111 and one of the connection portions can be tailored or otherwise customized. For example, a light engine 111 can be provided with a first connection portion having a maximum cross-sectional dimension and a second connection portion having a maximum cross-sectional dimension. The maximum cross-sectional dimension of the first connection portion can be different than the maximum cross-sectional dimension of the second connection portion. In such an implementation, a lighting device 100 can be formed by selecting one of the connection portions to releasably secure to the light engine 111 based on the dimensional requirements of a light fixture recess that the lighting device 100 is to be used with, for example.

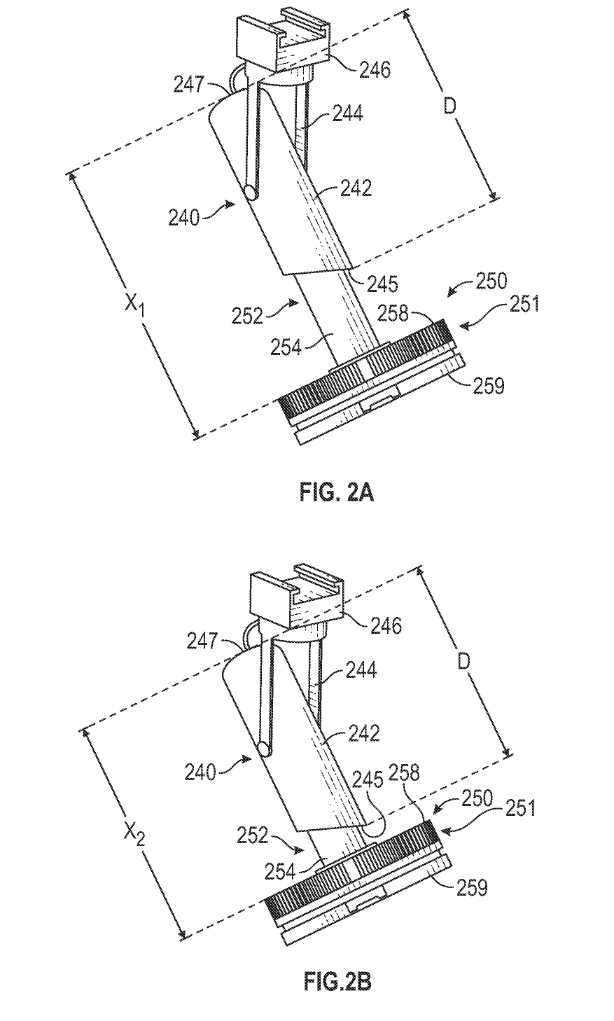

FIGS. 2A and 2B show side views of an example lighting device 250 illustrated with an example light fixture 240. As with the example lighting device 100 of FIG. 1A, the lighting device 250 includes a light engine 251 having a front side 259 and a back side 258. In some implementations, the front side 259 can include one or more light emitting surfaces and the back side 258 can be electrically and/or mechanically coupled to the connection portion 252. The connection portion 252 can include a stem 254 extending between the light engine 251 and a base connector, for example, an Edison screw or other connector, which may electrically and/or mechanically couple the lighting device 250 with the light fixture 240 (as shown in FIGS. 2A and 2B). As illustrated, the connection portion 252 has a length dimension X₁ that is adjustable or otherwise variable, as discussed in further detail below.

With reference to FIG. 2A, in some implementations, the light fixture 240 can include a track light fixture including a track mounting bracket 246, a recess casing 242, and one or more arms or extensions 244 connecting the recess casing 242 with the track mounting bracket 246. In some implementations, the track mounting bracket 246 may be fastened or otherwise secured to another structure, for example, a ceiling, to position the recess casing 242 within a given space or volume.

The recess casing 242 may extend between a first end 247 and a second end 245. The second end 245 may include an opening or aperture to allow at least a portion of the connection portion 252 to be disposed within the recess casing 242. In some implementations, the light fixture 240 can also include an electrical connection disposed within the recess casing 242 near the first end 247 and the electrical connection can electrically and/or mechanically engage the base connector of the lighting device 250 to electrically and/or mechanically couple the lighting device 250 to the light fixture 240. The recess casing 242 can have a depth dimension D defined between the first end 247 and the second end 245 and the depth dimension D can be less than the length dimension X₁ of the connection portion 252, as shown.

Turning now to FIG. 2B, the length dimension X₂ of the connection portion 252 has been adjusted to a value that is less than the length dimension X₁ shown in FIG. 2A. In this way, the back side 258 of the light engine 251 is disposed closer to the second side 245 of the recess casing 242. Thus, the position of the light engine 251 relative to the light fixture 240 can be changed or adjusted when the lighting device 250 is installed in the light fixture 240 by adjusting the length dimension X of the connection portion 252. In some implementations, the length dimension X of the connection portion 252 can be adjusted to match the depth dimension D of the recess casing 242 such that the back side 258 of the light engine 251 abuts, or is flush with, the second end 245 of the recess casing 242.

As will be readily apparent to those skilled in the art, FIGS. 2A and 2B schematically depict an example of how the lighting device 250 having a variable or adjustable length connection portion 252 can be installed within a recess of an example light fixture 240. First, the connection portion 252 of the lighting device 250 may be adjusted such that the connection portion 252 is sufficiently long to contact the electrical connection disposed within the recess casing 242 of the light fixture 240. Once adjusted to this length dimension X₁, the connection portion 252 may be temporarily locked at this first length dimension X₁ to facilitate installation into the light fixture 240, for example, to allow the connector of the lighting device 250 to be mechanically and/or electrically coupled to the electrical connection within the recess casing 242. After coupling the lighting device 250 to the electrical connection of the light fixture 240, the connection portion 252 may be released from the first position and adjusted to a second length dimension X₂ (FIG. 2B) such that the light engine 251 is disposed near the second end 245 of the recess casing 242. Once the connection portion 252 has been adjusted to the second length dimension X₂, the connection portion 252 may optionally be locked in this position or configuration such that the distance between the light engine 251 and the connector of the lighting device 250 is fixed, at least temporarily. In other words, the distance between the light engine 251 and the connector of the lighting device 250 can be set by optionally locking the connection portion 252 at the second length dimension X₂. In this way, the length dimension X of the connection portion 252 may be adjusted while coupled to the light fixture (for example, after the light engine 251 has been mechanically and/or electrically engaged with a light fixture) during installation. In other implementations, the length dimension X may be adjusted while it is not coupled to a light fixture (for example, prior to mechanically and/or electrically engaging the light engine 251 with a light fixture).

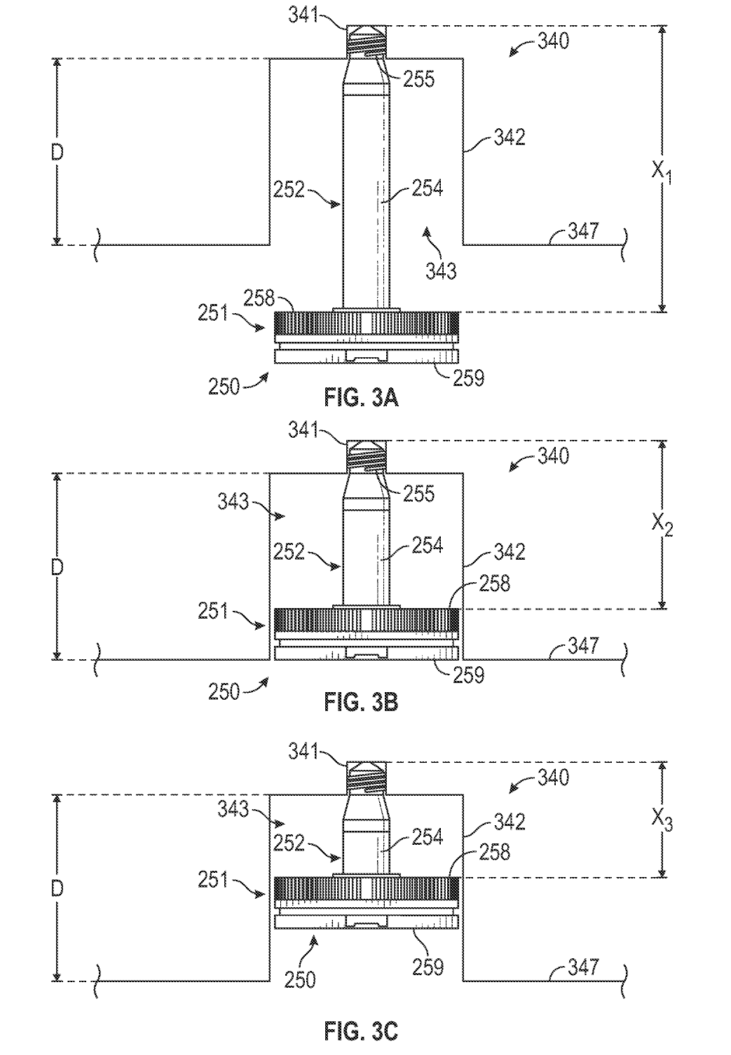

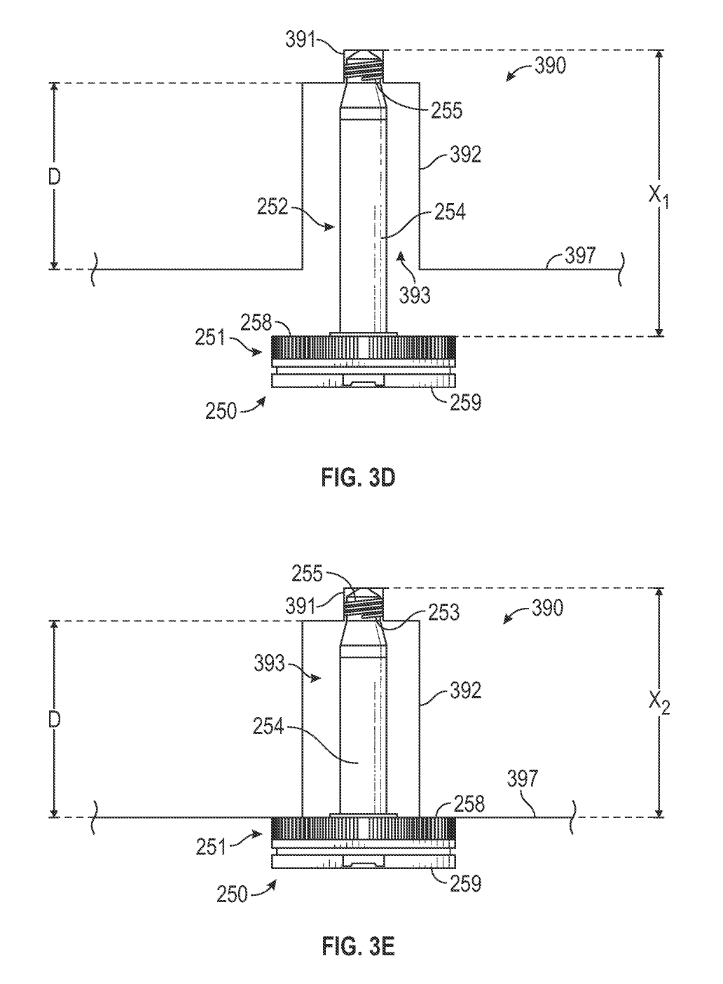

FIGS. 3A-3C show side views of the example lighting device 250 of FIGS. 2A and 2B illustrated with another example light fixture 340. In contrast to the track light fixture 240 of FIGS. 2A and 2B, the light fixture 340 of FIGS. 3A-3C includes a can 342 recessed relative to a surface 347. Thus, the light fixture 340 can be considered a “can fixture.” In some implementations, the surface 347 can include a ceiling to provide overhead lighting from a light engine installed within the light fixture 340. As shown, the can 342 defines a recess 343 having a depth dimension D. Further, an electrical connection 341 is disposed at an end of the can 342 that is opposite to the surface 347 and the electrical connection 341 can electrically and/or mechanically engage the base connector 255 of the lighting device 250 to electrically and/or mechanically couple the lighting device 250 to the light fixture 340.

FIGS. 3A-3C schematically depict an example of how the position of the light engine 251 can be adjusted or moved relative to the light fixture 340. For example, in FIG. 3A, the lighting device 250 is installed within the light fixture 340 (for example, the base connector 255 of the lighting device 250 is electrically and/or mechanically engaged with the electrical connection 341 of the light fixture 340 and the connection portion 252 is at least partially disposed within the recess 343) and the connection portion 252 of the lighting device 250 has a first length dimension X₁. As discussed above, in some implementations, the lighting device 250 can initially be installed within the light fixture 340 with the connection portion 252 locked, temporarily or permanently, at the first length dimension X₁, and then adjusted as desired.

In some implementations, after the connector 255 has been electrically and/or mechanically engaged with the electrical connection 341, the light engine 251 may be left in the position shown in FIG. 3A with the light engine 251 being disposed outside of the recess 343 of the light fixture 343. In some implementations, the position of the light engine 251 relative to the light fixture 340 and base connector 255 can be changed by adjusting or varying the length dimension X of the connection portion 252. For example, as shown in FIG. 3B, the length dimension X of the connection portion 252 can be adjusted to a second length dimension X₂ such that the front side 259 of the light engine 251 is flush or at least substantially flush with the surface 347 of the light fixture 340. In some implementations, the light engine 251 may be set in the position shown in FIG. 3B by locking, temporarily or permanently, the connection portion 252 at the second length dimension X₂. As shown in FIG. 3B, the light engine 251 may have a maximum radial dimension that fits within the recess 343 of the light fixture 340. However, in other implementations, the light engine 251 may be sized and shaped to have a maximum radial dimension that does not fit within the recess 343.

FIGS. 3D and 3E show side views of the example lighting device 250 of FIGS. 2A and 2B illustrated with another example light fixture 390. As with the light fixture 340 of FIGS. 3A-3C, the light fixture 290 includes a can 392 recessed relative to a surface 397 and an electrical connection 391 disposed at an end of the can 342 that is opposite to the surface 397. The can 392 defines a recess 393 having a depth D. However, in contrast to the light fixture 340 of FIGS. 3A-3C, the opening of the recess 393 is smaller than the light engine 251. As a result, the connection portion 252 of the light device 250 can be optionally adjusted between a first length dimension X₁ where the back side 258 of the light engine is offset from the surface 397 (FIG. 3D) and a second length dimension X₂ where the back side 258 of the light engine 251 is abuts the surface 397 of the light fixture 390 (FIG. 3E). Thus, the adjustment of the length dimension X of the connection portion 252 can be limited by the dimensions of the light engine 251 and recess 393, in some implementations.

In some implementations, the position of the light engine 251 relative to the light fixture 340 and connector 255 can be further changed by adjusting or varying the length dimension X of the connection portion 252 to a third length dimension X₃, shown in FIG. 3C. In some implementations, the third length dimension X₃ can be less than the first length dimension X₁ and second length dimension X₂ of FIGS. 3A and 3C. That is to say, the light engine 251 may be disposed within the recess 343 of the light fixture 340 when the connection portion 252 is adjusted to the third length dimension X₃. In this way, the front side 259 of the light engine 251 and the light emitting surface of the light engine 251 may be depressed or inset relative to the surface 347. In some implementations, the light engine 251 may be set in the position shown in FIG. 3C by locking, temporarily or permanently, the connection portion 252 at the third length dimension X₃. In this way, the light engine 251 of the lighting device 250 can be installed in different positions relative to a particular light fixture, for example, the light fixture 340 of FIGS. 3A-3C. Thus, the position of the light engine 251 relative to the light fixture 340 can be adjusted based on aesthetic, optical, and/or thermal requirements, for example.

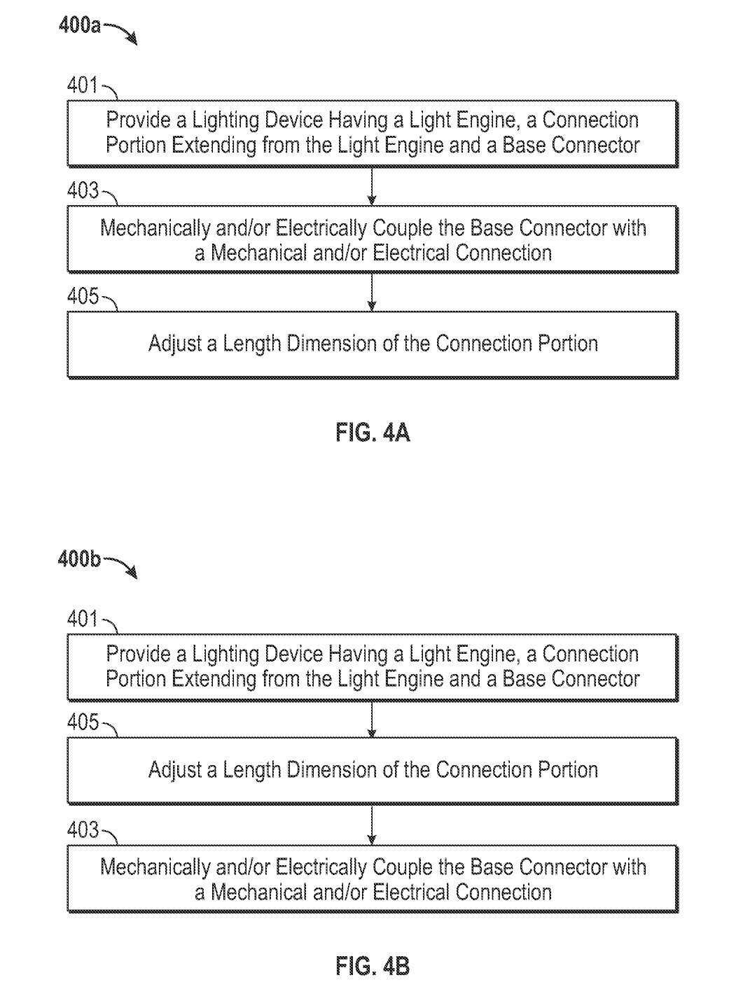

FIGS. 4A and 4B show flow diagrams illustrating example methods 400a, 400b of installing a lighting device. The example methods 400a, 400b can be used to install any of the lighting devices disclosed herein into a light fixture recess having an opening and an electrical connection disposed opposite to the opening. For example, the example methods 400a, 400b can be used to install the lighting devices 250 of FIGS. 2A-3C in the light fixture 240 of FIGS. 2A and 2B and/or the light fixture 340 of FIGS. 3A-3C.

As shown in FIGS. 4A and 4B, each example method 400a, 400b can include blocks 401, 403, and 405. Block 401 includes providing a lighting device having a light engine and a connection portion extending along a longitudinal axis of the lighting device. In some implementations, the light engine can have a light emitting surface and the connection portion can have a first end coupled to the light engine and a second end opposite the first end and coupled to a base connector. Block 403 includes coupling the connector with the electrical connection. In some implementations, coupling the connector with the electrical connection can include electrically and/or mechanically coupling the connector with the electrical connection. In some implementations, coupling the connector with the electrical connection includes simultaneously electrically and mechanically coupling the connector. Block 405 includes adjusting a length dimension of the connection portion between the first end and the second end to move a position of the light engine relative to the base connector between at least a first position and a second position.

As shown by comparing the method 400a of FIG. 4A and the method 400b of FIG. 4B, block 403 can come before and/or after block 405. That is to say, the length dimension of the connection portion can be adjusted when the base connector is coupled with the electrical connection and/or when the base connector is not coupled with the electrical connection. In this way, the position of the light engine relative to the connector can be adjusted before the lighting device is installed within the recess of the light fixture, during installation of the lighting device, and/or after the lighting device has been installed within the recess of the light fixture.

In some implementations, the length dimension of the connection portion when the light engine is in the first position can be greater than the length dimension of the connection portion when the light engine is in the second position. Thus, the light engine may be disposed nearer to the base connector when in the second position than when in the first position. In some implementations, the opening of the light fixture recess can be disposed between the light emitting surface and the electrical connection when the light engine is in the second position, the light emitting surface can be flush with the opening when the light engine is in the second position, or the light emitting surface can be disposed between the opening and the electrical connection when the light engine is in the second position. The example methods 400a and 400b can also include at least temporarily locking the connection portion when the light engine is in the first position and/or at least temporarily locking the connection portion when the light engine is in the second position. In this way, the position of the light engine relative to the base connector can be fixed, at least temporarily or secured by at least temporarily locking the length dimension of the connection portion.

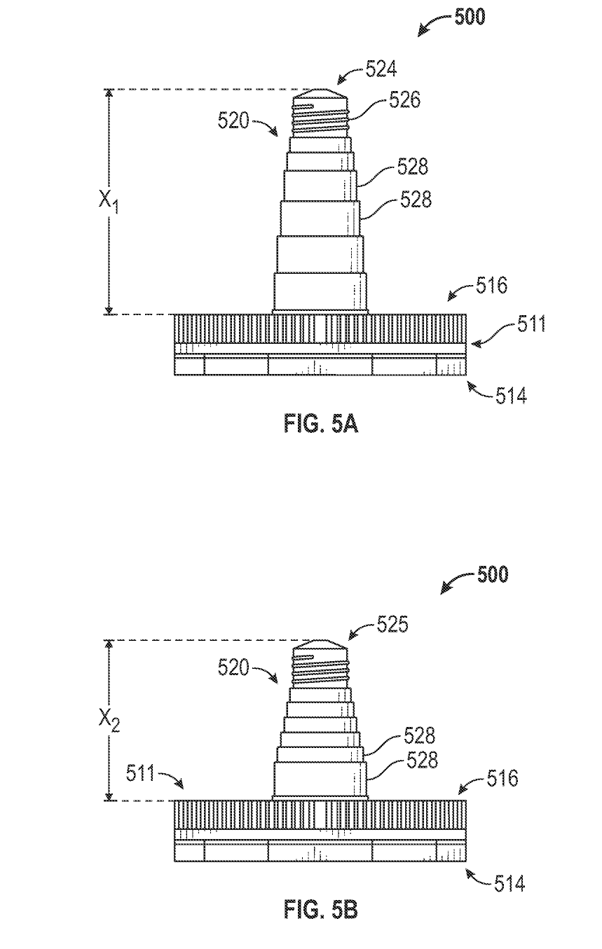

FIG. 5A shows a side view of an example lighting device 500 including a connection portion 520 having a length dimension X₁ that is adjustable. As with the lighting devices discussed herein, in some implementations, the lighting device 500 can include a light engine 511 having a front side 514 and a back side 516. The connection portion 520 can be electrically and/or mechanically coupled with back side 516 of the light engine 511 and can extend in the longitudinal direction away from the light engine 511.

In some implementations, the connection portion 520 includes a base connector 524, for example, an Edison screw, disposed opposite to the light engine 511 and configured to electrically and/or mechanically engage an electrical connection of a light fixture to electrically and/or mechanically couple the lighting device 500 with the light fixture. In some implementations, the connector 524 can include threads 526 for threadably engaging an electrical connection. In some implementations of this example and the other examples of lighting devices described and illustrated herein, the connection portion 520 does not include a base connector 524 but instead can be coupled to a variety of different base connectors, allowing base connectors having different configurations of electrical and mechanical connections that correspond with different types of electrical and mechanical receiving connections of light fixtures or sockets.

As shown in FIG. 5A, the connection portion 520 of the lighting device 500 can include a plurality of segments 528 disposed between the back side 516 of the light engine 511 and the connector 524. In some implementations, the segments 528 can form a stem structure disposed between the back side 516 of the light engine 511 and the base connector 524. Each segment 528 can have a maximum radial dimension that is less than a minimum radial dimension of the next most proximal segment 528. Further, each segment can have a minimum radial dimension that is greater than a maximum radial dimension of the next most distal segment 528. In this way, the length dimension X₁ of the connection portion 520 can be telescopically adjusted by moving or adjusting one or more of the segments 528 relative to one another.

FIG. 5B shows the example lighting device 500 of FIG. 5A with the length dimension X₂ of the connection portion 520 adjusted relative to the length dimension X₁ illustrated in FIG. 5A. Adjusting the length dimension X of the connection portion 520 can move the position of the base connector 524 relative to the light engine 511 between at least a first position, shown in FIG. 5A, and a second position, shown in FIG. 5B. In some implementations, the length dimension X₁ of the connection portion 520 when the light engine 511 is in the first position can be greater than the length dimension X₂ of the connection portion 520 when the light engine 511 is in the second position. Thus, adjusting the length dimension X of the connection portion 520 can move the position of the light engine 511 relative to the base connector 524. In this way, the length dimension X of the connection portion 520 of the lighting device 500 may be adjusted to install the lighting device 500 within recesses of various light fixtures and/or to adjust a position of the light engine 511 relative to a light fixture.

In some implementations, the lighting device 500 can include structure to at least temporarily lock the connection portion 520 when the light engine 511 is in the first position and/or to at least temporarily lock the connection portion 520 when the light engine 511 is in the second position. In some implementations, the locking structure can include a clip, for example, disposed inside the connection portion 520 and configured to limit the movement of the segments 528 relative to one another. In some implementations, each segment 528 can frictionally engage each adjacent segment 528. In such implementations, the frictional forces between segments 528 can increase by rotating the segments 528 relative to each other in a first direction and can decrease by rotating the segments 528 relative to each other in a second direction. In some implementations, the segments 528 can include one or more grooves that engage one or more protruding bosses disposed in adjacent segments 528. In this way, the grooves can releasably engage one or more bosses such that some force is necessary to collapse and/or expand the segments 528 from one another. In this way, the position of the light engine 511 relative to the base connector 524 can be fixed or secured, at least temporarily, by locking, at least temporarily, the length dimension X of the connection portion 520.

With reference to FIGS. 5A and 5B, in some implementations, the connection portion 520 may be biased from the first length dimension X₁ toward the second length dimension X₂ or from the second length dimension X₂ toward the first length dimension X₁ to facilitate installation of the lighting device 500 within a light fixture recess. For example, the connection portion 520 may be spring-loaded. In this way, the lighting device 500 may be installed in a light fixture having a recess depth that is equal to, or less than, the maximum length of the connection portion.

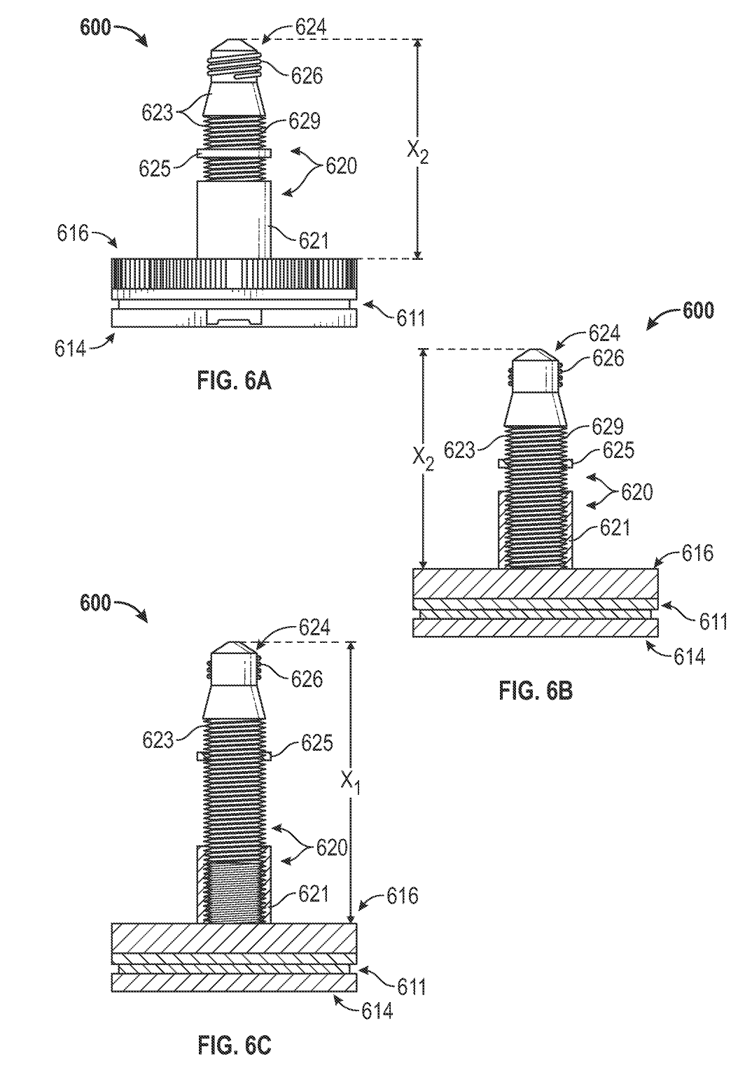

FIG. 6A shows a perspective view of an example lighting device 600 including a connection portion 620 having a length dimension X₁ that is adjustable. FIG. 6B shows a cross-sectional view of the example lighting device 600 of FIG. 6A. As shown in FIGS. 6A and 6B, in some implementations, the lighting device 600 can include a light engine 611 having a front side 614 and a back side 616. The connection portion 620 can be electrically and/or mechanically coupled with back side 616 of the light engine 611 and can extend in the longitudinal direction away from the light engine 611.

In some implementations, the connection portion 620 includes a base connector 624, for example, an Edison screw, disposed opposite to the light engine 611 and configured to electrically and/or mechanically engage an electrical connection to electrically and/or mechanically couple the lighting device 600 with a light fixture. In some implementations, the base connector 624 can include threads 626 for threadably engaging an electrical connection.

Still referring to FIGS. 6A and 6B, the connection portion 620 of the lighting device 600 can include a proximal portion 621 coupled to the back side 616 of the light engine 611 and a distal portion 623 extending between the proximal portion 621 and the base connector 624. As shown in FIG. 6B, in some implementations, the proximal portion 621 may be fixed relative to the light engine 611 and the distal portion 623 may include threads 629 which threadably engage the proximal portion 621. Thus, the length dimension X₂ of the connection portion 620 can be adjusted or changed by varying the length of thread 629 engagement between the distal portion 623 and the proximal portion 621. In this way, the length dimension X₂ of the connection portion 620 can be adjusted by rotating the proximal portion 621 relative to the distal portion 623 about the longitudinal axis, by rotating the distal portion 623 relative to the proximal portion 621 about the longitudinal axis, and/or by rotating the proximal portion 621 and distal portion 623 relative to one another about the longitudinal axis, for example.

In some implementations, the lighting device 600 can optionally include a stop washer 625 secured about the distal portion 623. The position of the stop washer 625 relative to the longitudinal length of the distal portion 623 may be selected to limit or set a range of movement of the connection portion 620. For example, the position of the stop washer 625 can be selected to provide a lower limit for the length dimension X of the connection portion 620 by limiting the length of thread 629 engagement between the distal portion 623 and the proximal portion 621.

FIG. 6C shows the example lighting device 600 of FIG. 6B with the length dimension X₁ of the connection portion 620 adjusted relative to the length dimension X₂ illustrated in FIGS. 6A and 6B. As illustrated, adjusting the length dimension X of the connection portion 620 can move the position of the base connector 624 relative to the light engine 611 between at least a second position, shown in FIGS. 6A and 6B, and a first position, shown in FIG. 6B. In some implementations, the length dimension X₂ of the connection portion 620 when the light engine 611 is in the second position can be less than the length dimension X₁ of the connection portion 620 when the light engine 611 is in the first position. Thus, adjusting the length dimension X of the connection portion 620 can move the position of the light engine 611 relative to the connector 624. In this way, the length dimension X of the connection portion 620 of the lighting device 600 may be adjusted to install the lighting device 600 within recesses of various light fixtures and/or to adjust a position of the light engine 611 relative to a light fixture.

In some implementations, the threads 629 of the distal portion 623 can be configured to at least temporarily lock the connection portion 620 when the light engine 611 is in the second position, when the light engine 611 is in the first position, and/or when the light engine 611 is in any other position. For example, the tolerance of the threads 629 can be selected such that a threshold torque or rotational force is required to change or adjust a length of thread 629 engagement between the distal portion 623 and the proximal portion 621, or the position may be temporarily locked with the stop washer 625. In this way, the position of the light engine 611 relative to the base connector 624 can be fixed or secured, at least temporarily, by locking, at least temporarily, the length dimension X of the connection portion 620.

Moreover, in some implementations, the of the torque for turning the distal portion 623 can be selected based, at least in part, on the torque for turning the base connector 624. For example, in some implementations, the threads of the distal portion 623 are a better match (i.e., closer to perfect fit and therefore have more rotational resistance) to the threads of the proximal portion 621 than the match of the threads 626 of the base connector such that the base connector 624 may adjusted through the base connector threads 626 by applying a lower amount of torque or rotational force than is required to adjust the length dimension X of the connection portion 620. For example, threads that have a “better match” can be threads that have a closer tolerance to the threads of the connector. In this way, the lighting device 600 may be mechanically and/or electrically coupled with an electrical connection via the base connector 624 before the length dimension X of the connection portion 620 is adjusted. Alternatively, the pitch of the connection portion 620 threads 629 may be less than, or equal to, the pitch of the base connector 624 threads 626.

FIG. 7A shows an exploded view of an example lighting device 700 including a connection portion 720 having a length dimension X that is adjustable. FIG. 7B shows a side view of the example lighting device 700 of FIG. 7A with the connection portion 720 temporarily locked in a first position. As shown in FIGS. 7A and 7B, in some implementations, the lighting device 700 can include a light engine 711 having a front side 714 and a back side 716. The connection portion 720 can be electrically and/or mechanically coupled with back side 716 of the light engine 711 and can extend in the longitudinal direction away from the light engine 711.

In some implementations, the connection portion 720 includes a base connector 724, for example, an Edison screw, disposed opposite to the light engine 711 and configured to electrically and/or mechanically engage an electrical connection to electrically and/or mechanically couple the lighting device 700 with a light fixture. In some implementations, the base connector 724 can include threads 726 for threadably engaging an electrical connection.

Still referring to FIGS. 7A and 7B, the connection portion 720 of the lighting device 700 can include a proximal portion 721 coupled to the back side 716 of the light engine 711 and a distal portion 723 extending between the proximal portion 721 and the base connector 724. In some implementations, the proximal portion 721 may be fixed relative to the light engine 711 and may receive at least a portion of the distal portion 723 through an aperture or opening disposed opposite to the light engine 711. In this way, the length dimension X of the connection portion 720 can be adjusted by moving the distal portion 723 relative to the proximal portion 721.

In some implementations, the proximal portion 721 can include a plurality of holes or openings 725 and the distal portion 723 can include one or more pins 727 sized and shaped to fit at least partially through the openings 725. The one or more pins 727 can optionally be movable relative to the distal portion 723. As a result, when the distal portion 723 is disposed at least partially within the proximal portion 721, the one or more pins 727 can be guided to, or aligned with, an opening 725 to engage the one or more pins 727 with at least one opening 725. In some implementations, the one or more pins 727 can be biased away from the longitudinal axis of the lighting device 700. For example, the one or more pins 727 can be spring loaded. Thus, engagement between the one or more pins 727 and at least one opening 725 can at least temporarily lock or secure a position of the distal portion 723 of the connection portion 720 relative to the proximal portion 721.

FIG. 7C shows the example lighting device 700 of FIG. 7B with the length dimension X₁ of the connection portion 720 adjusted relative to the length dimension X₂ illustrated in FIG. 7B and temporarily locked in a second position. As illustrated, adjusting the length dimension X of the connection portion 720 can move the position of the base connector 724 relative to the light engine 711 between at least a first position, shown in FIG. 7C, and a second position, shown in FIG. 7B. In some implementations, the length dimension X₂ of the connection portion 720 when the light engine 711 is in the second position can be less than the length dimension X₁ of the connection portion 720 when the light engine 711 is in the first position. Thus, adjusting the length dimension X of the connection portion 720 can move the position of the light engine 711 relative to the base connector 724. In this way, the length dimension X of the connection portion 720 of the lighting device 700 may be adjusted to install the lighting device 700 within recesses of various light fixtures and/or to adjust a position of the light engine 711 relative to a light fixture.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A lighting apparatus, comprising:
a light engine; and
a connection portion including a first end and a second end, the first end of the connection portion coupled to the light engine and extending from the light engine in a direction defining a longitudinal axis, the connection portion further including a base connector disposed at the second end of the connection portion, the base connector being electrically connected to the light engine through the connection portion,
wherein the connection portion has a length dimension that is adjustable between at least a first length that positions the base connector at a first position along the longitudinal axis relative to the light engine and a second length that positions the base connector at a second position along the longitudinal axis relative to the light engine.

2. The lighting device of claim 1, wherein the connection portion is lockable, at least temporarily, in at least one of the first and second positions.

3. The lighting device of claim 1, wherein a minimum cross-sectional dimension of the light engine is greater than a maximum cross-sectional dimension of the connection portion.

4. The lighting device of claim 1, wherein the length dimension of the connection portion can be adjusted between 1 inch and 9 inches.

5. The lighting device of claim 4, wherein the length dimension of the connection portion can be adjusted between 1 inch and 4 inches.

6. The lighting device of claim 4, wherein the length dimension of the connection portion can be adjusted between 4 inches and 9 inches.

7. The lighting device of claim 1, wherein the length dimension of the connection portion is telescopically adjustable.

8. The lighting device of claim 1, wherein the connection portion includes a spring to bias the connection portion toward the second length.

9. The lighting device of claim 1, wherein the light engine includes a light emitting surface and a back surface opposite to the light emitting surface, and wherein the connection portion is coupled to the back surface of the light engine.

10. The lighting device of claim 1, wherein the base connector includes at least one of an Edison screw, a BA5s connector, a BA7s connector, a BAX9s connector, a BA9s connector, a BA15d connector, a BAX15s connector, a BA15s connector, a BA20s connector, a BA20d connector, a B21d connector, a B21-4 connector, a BA22d connector, a BC-3 connector, a B22d-3 connector, a BX22d connector, a B15d connector, a BA15d connector, a BA15s connector, a BA20d connector, a B21s-4 connector, a B22d connector, a BY22d connector, a B24S-3 connector, a GU10 connector, a GZ10 connector, and a GU24 connector.

11. The light device of claim 1, wherein the light engine includes one or more LED elements configured to emit light and a light guide having a first surface and a second surface opposite the first surface, the light guide optically coupled to the one or more LED elements, wherein light emitted from the one or more LED elements is injected into the light guide through an input surface of the light guide, and wherein at least a portion of the light emitted from the one or more LED elements exits a second surface of the light guide.

12. The light device of claim 11, wherein the first surface and the second surface of the light guide meet at a peripheral edge of the light guide and define an angle therebetween of between 3 degrees and 5 degrees.

13. The light device of claim 12, wherein the light engine further includes one or more optical conditioners disposed adjacent to the second surface.

14. A lighting device having a longitudinal axis and comprising:
a light engine;
an electrical connector configured to connect to a light fixture; and
means for adjusting a longitudinal length dimension between the light engine and the connector, the length adjusting means coupled to the light engine and the electrical connector, wherein the length adjusting means is configured to adjust between at least a first length that positions the connector at a first position along the longitudinal axis relative to the light engine and a second length that positions the connector at a second position along the longitudinal axis relative to the light engine.

15. The device of claim 14, wherein the light adjusting means is at least temporarily lockable in at least one of the first and second positions.

16. The device of claim 14, wherein the light engine includes one of an incandescent bulb, a florescent tube, and a light engine.

17. The device of claim 14, wherein the connector includes an Edison screw.

18. The device of claim 14, wherein the length adjusting means includes a connection portion extending along the longitudinal axis, the connection portion having a first end and a second end, the first end of the connection portion being coupled to the light engine.

19. A method of installing a lighting device within a light fixture recess having an opening and an electrical connection opposite to the opening, the method comprising:
providing a lighting device having a light engine and a connection portion extending along a longitudinal axis of the lighting device, the light engine having a light emitting surface, the connection portion having a first end coupled to the light engine and a second end opposite the first end and coupled to a base connector;
coupling the base connector with the electrical connection; and
adjusting a length dimension of the connection portion between the first end and the second end to move a position of the light engine relative to the base connector between at least a first position and a second position.

20. The method of claim 19, wherein the length dimension of the connection portion when the light engine is in the first position is greater than the length dimension of the connection portion when the light engine is in the second position.

21. The method of claim 19, wherein the opening is disposed between the light emitting surface and the electrical connection when the light engine is in the second position.

22. The method of claim 19, wherein the light emitting surface is flush with the opening when the light engine is in the second position.

23. The method of claim 19, wherein the light emitting surface is disposed between the opening and the electrical connection when the light engine is in the second position.

24. The method of claim 19, further comprising locking, at least temporarily, the connection portion when the light engine is in the first position.

25. The method of claim 19, further comprising locking, at least temporarily, the connection portion when the light engine is in the second position.
